(19) United States
(12) Patent Application Publication
(10) Pub. No.: US 2008/0077702 A1
(43) Pub. Date: Mar. 27, 2008

(54) Dynamic server stream allocation

(76) Inventor: Joshua Posamentier, Oakland, CA (US)

Correspondence Address: INTEL/BLAKELY, 1279 OAKMEAD PARKWAY, SUNNYVALE, CA, 94085-4040, US

(21) Appl. No.: 11/528,832

(22) Filed: Sep. 27, 2006

(51) Int. Cl. G06F 15/16

(52) U.S. Cl. 709/232; 709/231

(57) ABSTRACT

Current media servers may offer several levels of media stream compression but do not dynamically recompress on the fly or moderate the quality of the streams to continuously maximize the experience for the client devices. Techniques described herein provide both dynamically adjustable compression and bandwidth allocation plus they take advantage of having otherwise unused processing power available on the server.

### TECHNICAL FIELD

Embodiments of the invention relate to streamed audio and/or video content. More particularly, embodiments of the invention relate dynamically adjusting compression and bandwidth parameters corresponding to requests for streamed audio and/or video content.

### BACKGROUND

Currently, media servers offer several levels of media compression and bandwidth allocation. Current media servers accept requests and then allocate a static amount of bandwidth and corresponding compression in response to a request for streamed data. However, bandwidth allocations and/or compression rates are typically selected based on worst-case scenario analysis and/or minimum acceptable performance levels. These bandwidth allocations and compression rates are not based on actual resource considerations. Therefore, current streaming technologies are inefficient.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 illustrates one embodiment of a client server architecture.

FIG. 2 is a flow diagram of one embodiment of a technique for dynamically allocating server streams.

FIG. 3 illustrates one embodiment of a data streaming management agent.

FIG. 4 is a block diagram of one embodiment of a device including a bandwidth allocation unit and compression-setting unit.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Current media servers may offer several levels of data compression but do not recompress on the fly or moderate the quality of the streams to maximize the experience for the client devices. Techniques described herein provide both of dynamically adjustable compression and bandwidth allocation plus takes advantage of having processing power available on the server.

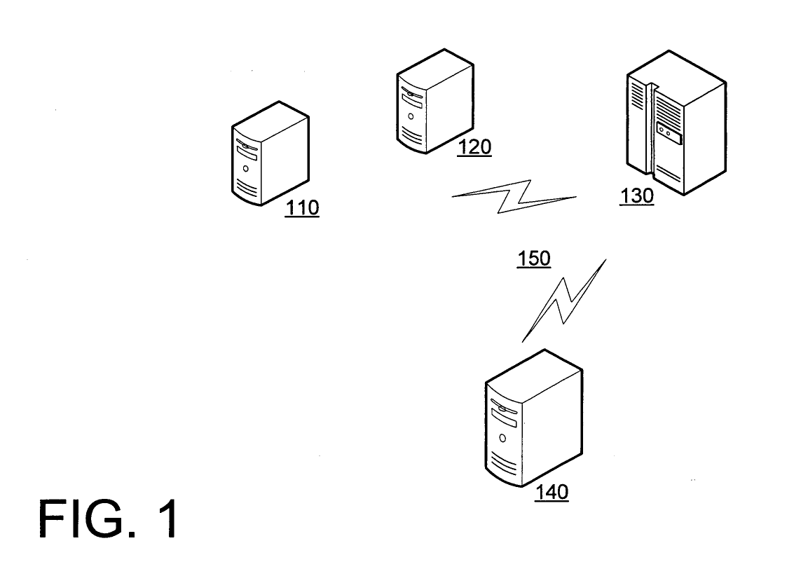

FIG. 1 illustrates one embodiment of a client server architecture. In one embodiment, media server 130 may be connected through communication link 150 to client 140. Media server 130 may contain video, audio, or other type of electronic files that may be streamed to client 140. Communication link 150 may be a wireless or hardwired communication link utilizing any communications protocol known in the art.

If, for example, client 140 is the first client to request streamed data from media server 130, media server 130 may stream the requested data to client 140 at the highest possible quality and utilizing the maximum available bandwidth. In response to additional requests for streamed data from media server 130 generated by, for example, client 110 or client 120, media server 130 may modify the bandwidth and/or quality (e.g., compression) parameters accordingly.

For example, media server 130 may compress one or more of the data streams destined for client 110, client 120 and/or client 140. Thus, media server 130 may attempt to provide the least compression possible. The compression levels utilized by media server 130 may be based, at least in part, on the number of clients requesting streamed data and/or available bandwidth.

Media server 130 may also modify bandwidth allocated to one or more of the data streams destined for client 110, client 120 and/or client 140 based, at least in part, on the number of clients requesting streamed data and/or compression levels/techniques used for the corresponding streams. That is, both bandwidth allocation compression and bandwidth may be dynamically modified and an appropriate compression technique selected based on current or anticipated conditions that may include the number of clients receiving streamed data.

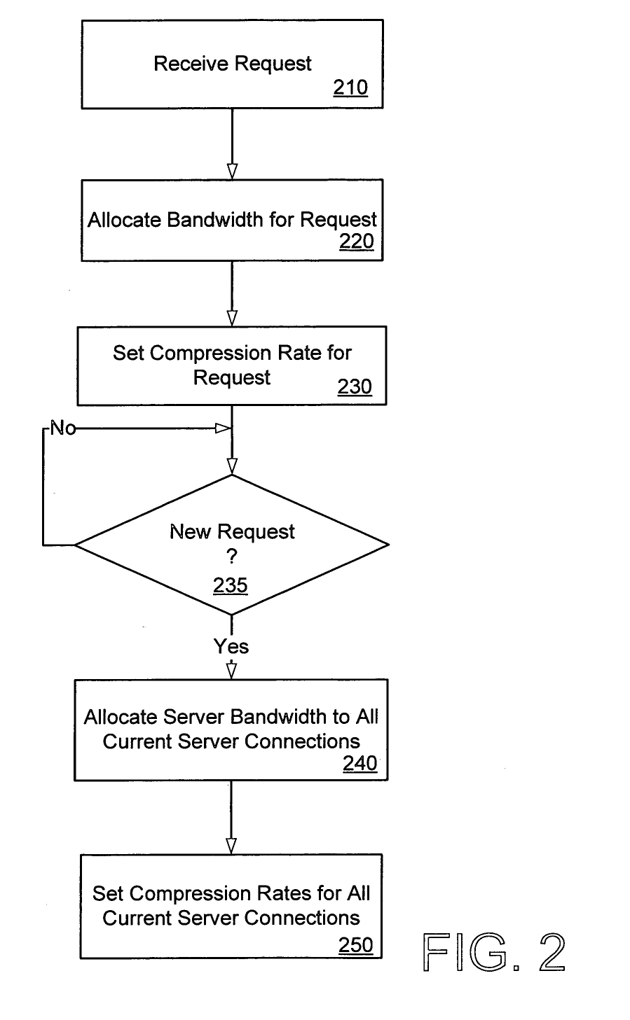

FIG. 2 illustrates a technique for allocating a new server request based on quality parameters. The technique of FIG. 2 may be performed by a media server or other device that may provide streaming content. In one embodiment, the media server may have a data streaming management agent that performs the technique of FIG. 2. The ordering of operations in FIG. 2 is for description purposes only. Various embodiments may be implemented in which operations are performed in a different ordering. For example, a dedicated media server may store or cache fall uncompressed digital media locally. The uncompressed audio stream may be, for example, a 150 kBps uncompressed audio CD-quality stream (1200 kbps) from a local radio station.

The data streaming management agent may receive a request for streamed data from a client device, 210. The data streaming management agent may attempt to maximize the sound quality to the listeners while not exceeding the available network link bandwidth (e.g., a 10 Mbps internet uplink in a metro area network). In one embodiment, the server may factor in an overhead factor for the link (e.g., if overhead consumes ˜10% of the link then 9 Mbps is available to serve media).

The request, 210, may be for the audio stream at full quality. The server may provide the streamed data over the network at full quality limited only by the user's downlink speed. If, for example, the requesting client has an associated 1.5 Mbps downlink speed, the full quality request may utilizes ˜14% of the available bandwidth.

In response to the request, the data streaming management agent may set quality parameters for the received request by allocating bandwidth for the request based on the available bandwidth not being used by current connections to the media server, 220. A compression rate may also be selected, 230.

Streaming of data may continue utilizing the parameters discussed above until a new request is received, 235. When a new request is received, 235, the data streaming management agent may allocate bandwidth to all server connections. That is, the streaming data management agent may dynamically readjust the current connections, 240 to allocate server bandwidth to the connected servers including the most recent request. The data streaming management agent may further set compression rates for the current connections based, at least in part, on the bandwidth allocated to the various connections, 250. Also, no symmetry in bandwidth or compression is required amongst the streams to the different clients. Each client may receive a different level of compressed stream depending on a variety of factors including, for example, subscription level, client side bandwidth, link provider quality of service deprioritization, or client processing capability. Other factors may also be used.

For example, nine additional client devices join the audio stream for the beginning of a specific program. Now, the demand for uncompressed audio rises to 12 Mbps, which is greater than the available 9 Mbps. In response to this increased bandwidth demand, the server may compress the audio stream faster than real-time to any format known in the art (e.g., AAC, MP3, OGG, WMA) that has variable bit rate encoding.

For present example, we assume use of MP3 encoding, which is easily recompressed much faster than real-time on most current processors; however other encoding techniques may also be used. The ten client devices may be served audio streams that are compressed to ˜900 kbps—nearly full quality. In one embodiment, each stream may be encoded based on the needs of each particular client. In alternate embodiments, all clients may receive comparable streams.

As discussed above, each connection may have a unique combination of bandwidth and compression based on parameters corresponding to the connection. As another example, two or more classes of bandwidth and compression combinations may be designated and assigned to connections based on current conditions. Note that the bandwidth and compression utilized may be reevaluated and changes may be made dynamically. In one embodiment, bandwidth and compression are reevaluated for each connection each time a new connection is requested. Other triggering conditions may also be utilized, for example, length of connection, time of day, anticipated loads, and/or any further relevant conditions.

The process described above may continue and be dynamically adjusted as requests are received. For example, if 90 additional client devices request the audio stream from this server for a total of 100 users the per-user bandwidth is only 90 kbps—mediocre MP3 quality. Because the objective is to maximize audio quality for as many clients as possible, the server may change compression ratio(s) such that the uncompressed audio is compressed into a 90 kbps MP3 in an attempt to maximize utilization of the network uplink. This process can continue until some threshold is reached where the quality of the media is unacceptable—say 32 kbps for MP3 formatted files. At this point, new connections may be denied until additional servers and/or additional bandwidth can be provided to serve all requests.

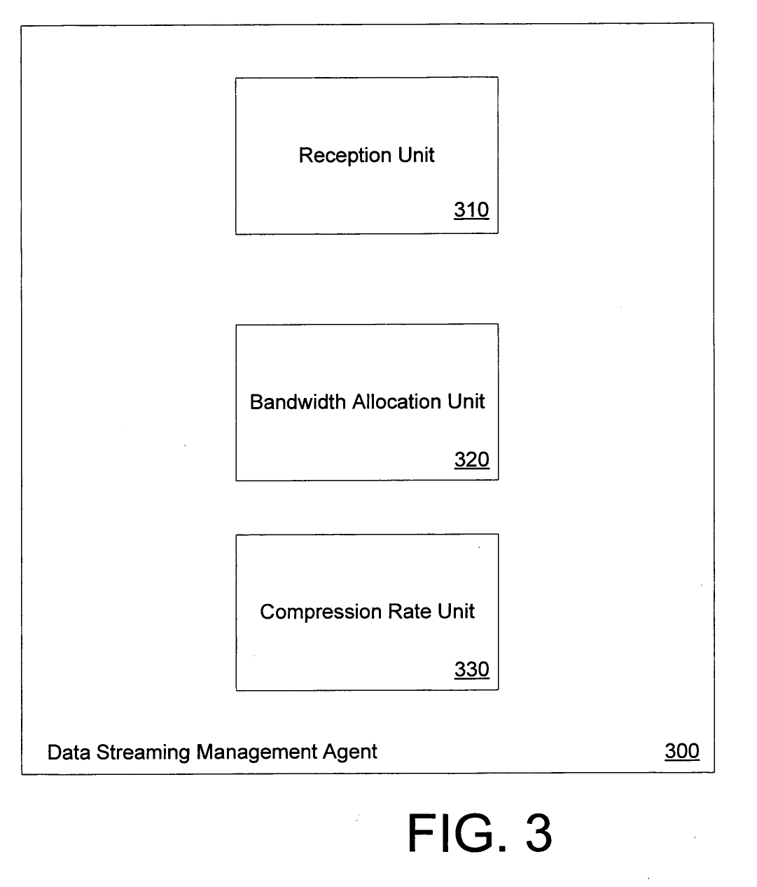

FIG. 3 illustrates one embodiment of a data streaming management agent. The operation flow of data streaming management agent 300 may correspond to the technique in FIG. 2. The units of data streaming management agent 300 may be implemented as hardware, software, firmware or any combination thereof.

Agent 300 may include reception unit 310 that may receive and/or process data stream requests from client devices requesting data to be streamed from a host media server, such as media server 130. Bandwidth allocation agent 320 may allocate bandwidth for the received requests and for current requests that need to be re-allocated bandwidth. Compression Rate unit 330 may set compression rates for the received request and may re-set compression rates for current requests that have been re-allocated bandwidth.

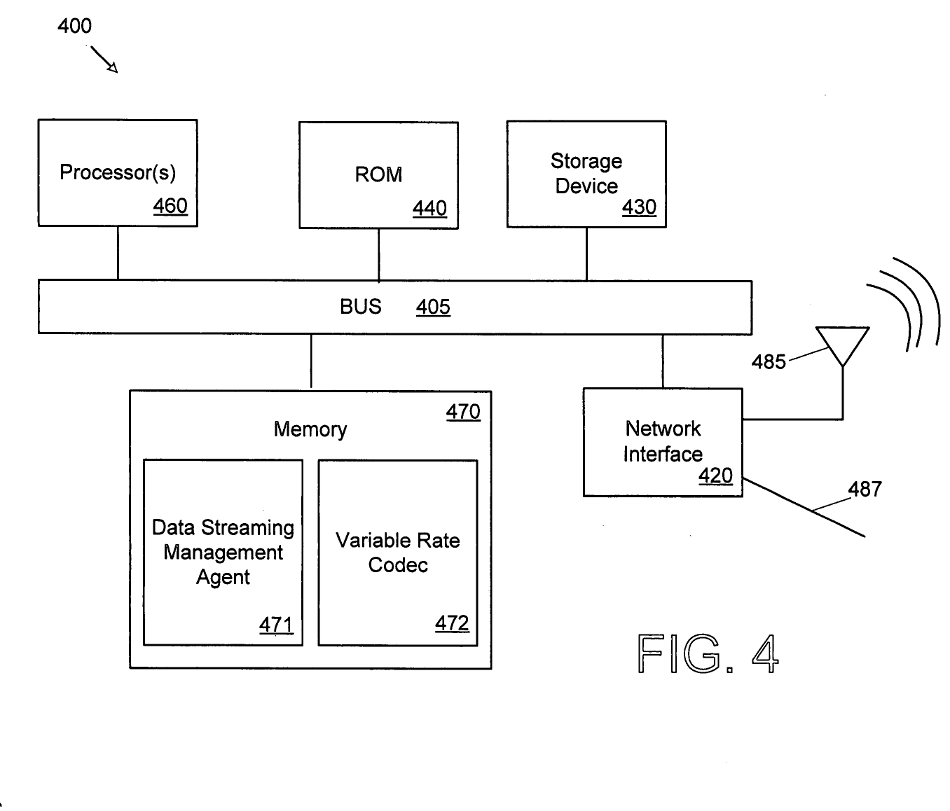

FIG. 4 illustrates one illustrates one embodiment of a device that may allocate bandwidth and determine compression rates. Device 400 may be implemented in a receiving, transmitting, wireless, broadband wired, access point or any combination of these type of device. Alternative devices may include more, fewer and/or different components. Device 400 may include bus 405 or other communication device to communicate information, and processor 460 coupled to bus 405 that may process information. While device 400 is illustrated with a single processor, device 400 may include multiple processors and/or co-processors.

Device 400 further may include random access memory (RAM) or other dynamic storage device 430, coupled to bus 405 and may store information and instructions that may be executed by processor 460. Memory 470 may be used to store temporary variables or other intermediate information during execution of instructions by processor 460. Memory 470 may include any type of memory known in the art, for example, dynamic random access memory (DRAM), static random access memory (SRAM), flash memory, etc.

In one embodiment, memory 470 may include any type of computer-readable storage medium that provides content (e.g., computer executable instructions) in a form readable by an electronic device (e.g., a computer, a personal digital assistant, a cellular telephone). For example, a machine-accessible medium includes read only memory (ROM); random access memory (RAM); magnetic disk storage media; optical storage media; flash memory devices; etc.

Memory 470 may further include data streaming management unit 471. The process of data streaming management unit 471 may be implemented as instructions stored in memory 470 that are executed by processor 460. Alternatively, data streaming management unit 471 may be coupled to the bus, (not shown), as an independent circuitry that may interact with processor 460. Each unit of data streaming management unit 471 may be implemented as hardware, software, firmware, or a combination of these.

Memory 470 may also include variable rate codec unit 472. Variable rate codec unit 472 may set and re-set compression rates for media files. The process of variable rate codec unit 472 may be implemented as instructions stored in memory 470 that are executed by processor 460. Alternatively, variable rate codec unit 472 may be coupled to the bus, (not shown), as an independent circuitry that may interact with processor 460. Each unit of variable rate codec unit 472 may be implemented as hardware, software, firmware, or a combination of these.

Device 400 may also include read only memory (ROM) 440 and/or other static storage device 430 coupled to bus 405 to store information and instructions. Data storage device 430 may be a magnetic disk or optical disk and the corresponding drives may be coupled to device 400.

Device 400 may further include network interface(s) 420 to provide access to a network. Network interface(s) may include, for example, a wireless network interface having one or more omnidirectional antennae 485. Network interface(s) 420 may also include, for example, a wired network interface to communicate with remote devices via network cable 487, which may be, for example, an Ethernet cable, a coaxial cable, a fiber optic cable, a serial cable, or a parallel cable. Device 400 may include additional and/or different components.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
dynamically allocating server bandwidth for streamed data in response to a request from a remote device based, at least in part, on parameters corresponding to a connection carrying the request;
dynamically adjusting a compression rate corresponding to the allocated bandwidth for the request;
receiving a subsequent request from an additional remote device for the streamed data;
dynamically allocating server bandwidth for streamed data for the remote device and for the additional remote device based, at least in part, on connection parameters corresponding to the request and the subsequent request; and
dynamically setting compression rates for the remote device and for the additional remote device for the streamed data based, at least in part, on the bandwidth allocation for the remote device and for the additional remote device.

2. The method of claim 1 wherein the streamed data comprises audio/video data.

3. The method of claim 1 wherein allocating server bandwidth for the request comprises providing sufficient bandwidth to stream an uncompressed data stream if the required bandwidth does not exceed available bandwidth.

4. The method of claim 3 wherein setting a compression rate corresponding to the allocated bandwidth for the request comprises selecting a codec based on available bandwidth if the available bandwidth is not sufficient to stream an uncompressed data stream.

5. The method of claim 1 wherein allocating server bandwidth for streamed data for the remote device and for the additional remote device based, at least in part, on connection parameters corresponding to the request and the subsequent request comprises:
determining a total available server bandwidth; and
dynamically allocating a portion of the available server bandwidth to each request to be serviced.

6. The method of claim 5 wherein setting compression rates for the remote device and for the additional remote device for the streamed data based, at least in part, on the bandwidth allocation for the remote device and for the additional remote device comprises:
dynamically determining a compression rate for each request based, at least in part, on a bandwidth allocated to each request; and
selecting a codec based for each request based, at least in part, on the compression rate determined for the corresponding request.

7. An article comprising a computer-readable medium having stored thereon instructions that, when executed, cause one or more processors to:
dynamically allocate server bandwidth for streamed data in response to a request from a remote device based, at least in part, on parameters corresponding to a connection carrying the request;
dynamically adjust a compression rate corresponding to the allocated bandwidth for the request;
receive a subsequent request from an additional remote device for the streamed data;
dynamically allocate server bandwidth for streamed data for the remote device and for the additional remote device based, at least in part, on connection parameters corresponding to the request and the subsequent request; and
dynamically set compression rates for the remote device and for the additional remote device for the streamed data based, at least in part, on the bandwidth allocation for the remote device and for the additional remote device.

8. The article of claim 7 wherein the streamed data comprises audio/video data.

9. The article of claim 7 wherein the instructions that cause the one or more processors to allocate server bandwidth for the request comprise instructions that, when executed, cause the one or more processors to provide sufficient bandwidth to stream an uncompressed data stream if the required bandwidth does not exceed available bandwidth.

10. The article of claim 9 wherein the instructions that cause the one or more processors to set a compression rate corresponding to the allocated bandwidth for the request comprise instructions that, when executed, cause the one or more processors to select a codec based on available bandwidth if the available bandwidth is not sufficient to stream an uncompressed data stream.

11. The article of claim 7 wherein the instructions that cause the one or more processors to allocate server bandwidth for streamed data for the remote device and for the additional remote device based, at least in part, on connection parameters corresponding to the request and the subsequent request comprise instructions that, when executed, cause the one or more processors to:
determine a total available server bandwidth; and
dynamically allocate a portion of the available server bandwidth to each request to be serviced.

12. The article of claim 11 wherein the instructions that cause the one or more processors to set the compression rates for the remote device and for the additional remote device for the streamed data based, at least in part, on the bandwidth allocation for the remote device and for the additional remote device comprise that, when executed, cause the one or more processors to:
dynamically determine a compression rate for each request based, at least in part, on a bandwidth allocated to each request; and
select a codec based for each request based, at least in part, on the compression rate determined for the corresponding request.

13. A system comprising:
a server device coupled to a network via a network cable, the server device having
a memory to store instructions; and
one or more processors coupled with the memory to execute instructions, the instructions, when executed, cause the one or more processors to allocate server bandwidth for streamed data in response to a request from a remote device based, at least in part, on parameters corresponding to a connection carrying the request, to set a compression rate corresponding to the allocated bandwidth for the request, to receive a subsequent request from an additional remote device for the streamed data, to allocate server bandwidth for streamed data for the remote device and for the additional remote device based, at least in part, on connection parameters corresponding to the request and the subsequent request, and to set compression rates for the remote device and for the additional remote device for the streamed data based, at least in part, on the bandwidth allocation for the remote device and for the additional remote device.

14. The system of claim 13 wherein the streamed data comprises audio/video data.

15. The system of claim 13 wherein the instructions that cause the one or more processors to allocate server bandwidth for the request comprise instructions that, when executed, cause the one or more processors to provide sufficient bandwidth to stream an uncompressed data stream if the required bandwidth does not exceed available bandwidth.

16. The system of claim 15 wherein the instructions that cause the one or more processors to set a compression rate corresponding to the allocated bandwidth for the request comprise instructions that, when executed, cause the one or more processors to select a codec based on available bandwidth if the available bandwidth is not sufficient to stream an uncompressed data stream.

17. The system of claim 13 wherein the instructions that cause the one or more processors to allocate server bandwidth for streamed data for the remote device and for the additional remote device based, at least in part, on connection parameters corresponding to the request and the subsequent request comprise instructions that, when executed, cause the one or more processors to:
determine a total available server bandwidth; and
dynamically allocat a portion of the available server bandwidth to each request to be serviced.
